(19) United States
(12) Patent Application Publication
(10) Pub. No.: US 2025/0350440 A1
(43) Pub. Date: Nov. 13, 2025

(54) TECHNIQUES FOR SUBBAND FULL DUPLEX OPERATION

(71) Applicant: QUALCOMM Incorporated, San Diego, CA (US)

(72) Inventors: Prashant SHARMA, San Marcos, CA (US); Muhammad Sayed Khairy ABDELGHAFFAR, San Jose, CA (US); Jae Ho RYU, San Diego, CA (US)

(21) Appl. No.: 18/657,530

(22) Filed: May 7, 2024

(51) Int. Cl. H04L 5/14; H04W 72/12; H04W 72/51; H04W 76/20

(52) U.S. Cl. CPC H04L 5/1469; H04W 72/12; H04W 72/51; H04W 76/20

(57) ABSTRACT

Methods, systems, and devices for wireless communications are described. Techniques described herein provide subband full duplex (SBFD) operation. In some examples, a network entity may receive first information that is indicative of a SBFD configuration, and the network entity may receive second information that is indicative of a time division duplex (TDD) configuration. The network entity may transmit an indication that indicates operation of the network entity in an SBFD mode or in a non-SBFD mode. Operation of the network entity in the SBFD mode may be in accordance with the SBFD configuration, and operation of the network entity in the non-SBFD mode may be in accordance with the TDD configuration.

### INTRODUCTION

The following relates to wireless communications, including techniques for subband full duplex operation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first information that is indicative of a subband full duplex (SBFD) configuration, receiving second information that is indicative of a time division duplex (TDD) configuration, and transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

A UE for wireless communications is described. The UE may include one or more memories storing processor executable code, and one or more processors coupled with the one or more memories. The one or more processors may individually or collectively be operable to execute the code to cause the UE to receive first information that is indicative of a SBFD configuration, receive second information that is indicative of a TDD configuration, and transmit an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

Another UE for wireless communications is described. The UE may include means for receiving first information that is indicative of a SBFD configuration, means for receiving second information that is indicative of a TDD configuration, and means for transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

A non-transitory computer-readable medium storing code for wireless communications is described. The code may include instructions executable by one or more processors to receive first information that is indicative of a SBFD configuration, receive second information that is indicative of a TDD configuration, and transmit an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

Some examples of the method, user equipment (UEs), and non-transitory computer-readable medium described herein may further include operations, features, means, or instructions for receiving, responsive to transmission of the indication, third information that schedules an uplink or downlink transmission in an SBFD resource in accordance with the SBFD configuration, where the indication may be indicative of operation of the network entity in the SBFD mode.

Some examples of the method, user equipment (UEs), and non-transitory computer-readable medium described herein may further include operations, features, means, or instructions for receiving, responsive to transmission of the indication, third information that schedules an uplink or downlink transmission in a resource in accordance with the TDD configuration, where the indication may be indicative of operation of the network entity in the non-SBFD mode.

In some examples of the method, user equipment (UEs), and non-transitory computer-readable medium described herein, transmission of the indication occurs as part of an initial access procedure.

In some examples of the method, user equipment (UEs), and non-transitory computer-readable medium described herein, the indication may be indicative of operation of the network entity in the non-SBFD mode based on participation of the network entity in the initial access procedure and based on the SBFD configuration, a first quantity of bandwidth part switching supported by the network entity, a second quantity of downlink to uplink switching or uplink to downlink switching supported by the network entity, or a combination thereof.

In some examples of the method, user equipment (UEs), and non-transitory computer-readable medium described herein, transmission of the indication occurs while the network entity may be in a radio resource control connected mode.

In some examples of the method, user equipment (UEs), and non-transitory computer-readable medium described herein, the indication may be indicative of operation of the network entity in the non-SBFD mode based on the network entity being in the radio resource control connected mode and based on a first quantity of bandwidth part switching supported by the network entity, a second quantity of downlink to uplink switching or uplink to downlink switching supported by the network entity, a third quantity of cross link interference experienced by the network entity, a fourth quantity of uplink data available for transmission, a bandwidth part configuration of the SBFD configuration supported by the network entity, or a combination thereof.

In some examples of the method, user equipment (UEs), and non-transitory computer-readable medium described herein, the transmission of the indication occurs as part of a UE assistance information transmission.

In some examples of the method, user equipment (UEs), and non-transitory computer-readable medium described herein, the indication may be indicative of operation of the network entity in the non-SBFD mode based on participation of the network entity in transmission of the UE assistance information transmission and based on one or more events of a bandwidth part of the SBFD configuration after a bandwidth part switch supported by the network entity, a change in cell conditions associated with the network entity, or a change in a quantity of uplink data available for transmission.

In some examples of the method, user equipment (UEs), and non-transitory computer-readable medium described herein, the indication indicates the one or more events.

In some examples of the method, user equipment (UEs), and non-transitory computer-readable medium described herein, transmission of the indication occurs while the network entity may be in a radio resource control inactive mode or a radio resource control idle mode.

In some examples of the method, user equipment (UEs), and non-transitory computer-readable medium described herein, the transmission of the indication occurs as part of capability signaling or feature support signaling.

In some examples of the method, user equipment (UEs), and non-transitory computer-readable medium described herein, transmission of the indication occurs as part of a random access procedure.

In some examples of the method, user equipment (UEs), and non-transitory computer-readable medium described herein, the indication includes a random access preamble or the indication may be associated with a random access occasion.

Some examples of the method, user equipment (UEs), and non-transitory computer-readable medium described herein may further include operations, features, means, or instructions for transmitting a message, subsequent to the indication, that indicates a condition associated with the non-SBFD mode.

Some examples of the method, user equipment (UEs), and non-transitory computer-readable medium described herein may further include operations, features, means, or instructions for transmitting a message, subsequent to the first information, that indicates a SBFD period associated with the SBFD configuration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for subband full duplex (SBFD) operation in accordance with one or more aspects of the present disclosure.

FIG. 2 shows an example of a wireless communications system that supports techniques for SBFD operation in accordance with one or more aspects of the present disclosure.

FIG. 3 shows an example of a resource diagram that supports techniques for SBFD operation in accordance with one or more aspects of the present disclosure.

FIG. 4 shows an example of a process flow that supports techniques for SBFD operation in accordance with one or more aspects of the present disclosure.

FIGS. 5 and 6 show block diagrams of devices that support techniques for SBFD operation in accordance with one or more aspects of the present disclosure.

FIG. 7 shows a block diagram of a communications manager that supports techniques for SBFD operation in accordance with one or more aspects of the present disclosure.

FIG. 8 shows a diagram of a system including a device that supports techniques for SBFD operation in accordance with one or more aspects of the present disclosure.

FIGS. 9 and 10 show block diagrams of devices that support techniques for SBFD operation in accordance with one or more aspects of the present disclosure.

FIG. 11 shows a block diagram of a communications manager that supports techniques for SBFD operation in accordance with one or more aspects of the present disclosure.

FIG. 12 shows a diagram of a system including a device that supports techniques for SBFD operation in accordance with one or more aspects of the present disclosure.

FIGS. 13 through 16 show flowcharts illustrating methods that support techniques for SBFD operation in accordance with one or more aspects of the present disclosure.

### DETAILED DESCRIPTION

A wireless communication system may support duplex communications. In some cases, the wireless communication system may support time division duplexing (TDD), and the wireless devices may perform wireless communication (e.g., downlink communication, uplink communication) on a same frequency resource and over one or multiple different time resources (e.g., symbols, slots). TDD may enable both downlink communication and uplink communication over a same frequency resource using different time resources (e.g., symbols, slots). In some cases, the wireless communication system may support sub-band full duplex (SBFD). In SBFD, the wireless devices may perform downlink communication over a downlink subband and uplink communication over an uplink subband, and the downlink subband and the uplink subband may be nonoverlapping. In SBFD, a network entity may configure one or more SBFD slots or symbols of a component carrier with both uplink resources (e.g., one or more uplink sub-bands) and downlink resources (e.g., one or more downlink sub-bands). In some cases, a user equipment (UE) may support SBFD operation, and the UE may communicate using both uplink resources and downlink resources in an SBFD slot. In some cases, the UE may support SBFD operation, and the UE may communicate using either uplink resources or downlink resources in an SBFD symbol. In some cases, the UE may not have a high quantity of uplink data and may operate under good serving cell conditions, and operating in SBFD may involve additional implementation complexity and power consumption by the UE.

Techniques for reducing implementation complexity and power consumption may be employed by the UE while supporting the SBFD operation. For example, the UE may indicate to the network entity whether to operate in a SBFD mode or a non-SBFD mode. In some examples, a UE may receive first information that is indicative of a SBFD configuration. The UE may receive second information that is indicative of a TDD configuration. The UE may transmit an indication that indicates operation of the UE in an SBFD mode or in a non-SBFD mode. The operation of the UE in the SBFD mode is in accordance with the SBFD configuration, and the operation of the UE in the non-SBFD mode is in accordance with the TDD configuration. If the UE indicates the SBFD mode, the UE may receive third information that schedules an uplink or downlink transmission in an SBFD resource in accordance with the SBFD configuration. If the UE indicates the non-SBFD mode, the UE may receive third information that schedules an uplink or downlink transmission in a resource in accordance with the TDD configuration. In some examples, the transmission of the indication may occur as part of an initial access procedure. In some cases, the transmission of the indication occurs during a radio resource control (RRC) connected mode, RRC idle mode, or RRC inactive mode. In some cases, the transmission of the indication may occur as part of a random access procedure.

Aspects of the disclosure are initially described in the context of wireless communications systems. Aspects of the disclosure are then described with reference to a resource diagram and a process flow. Aspects of the disclosure are further illustrated by and described with reference to apparatus diagrams, system diagrams, and flowcharts that relate to techniques for SBFD operation.

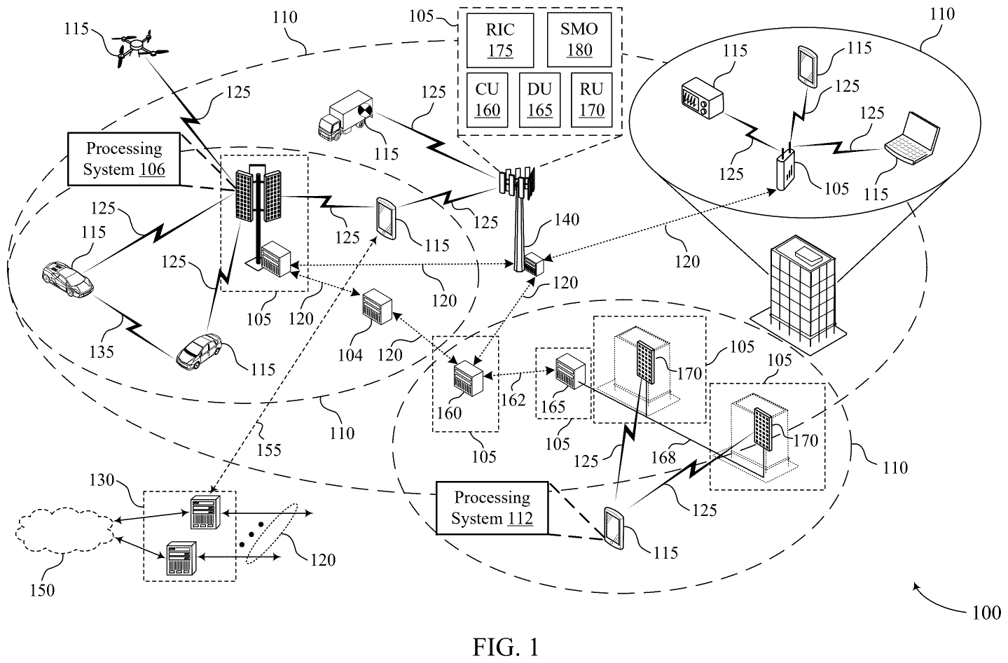

FIG. 1 shows an example of a wireless communications system 100 that supports techniques for SBFD operation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A wireless communication system may support duplex communications. In some cases, the wireless communication system may support time division duplexing (TDD), and the wireless devices may perform wireless communication (e.g., downlink communication, uplink communication) on a same frequency resource and over one or multiple different time resources (e.g., symbols, slots). TDD may enable both downlink communication and uplink communication over a same frequency resource using different time resources (e.g., symbols, slots). In some cases, the wireless communication system may support sub-band full duplex (SBFD). In SBFD, the wireless devices may perform downlink communication over a downlink subband and uplink communication over an uplink subband, and the downlink subband and the uplink subband may be nonoverlapping. In SBFD, a network entity 105 may configure one or more SBFD slots or symbols of a component carrier with both uplink resources (e.g., one or more uplink sub-bands) and downlink resources (e.g., one or more downlink sub-bands). In some cases, a UE 115 may support SBFD operation, and the UE 115 may communicate using both uplink resources and downlink resources in an SBFD slot. In some cases, the UE 115 may support SBFD operation, and the UE 115 may communicate using either uplink resources or downlink resources in an SBFD symbol. In some cases, the UE 115 may not have a high quantity of uplink data and may operate under good serving cell conditions, and operating in SBFD may involve additional implementation complexity and power consumption by the UE 115.

Techniques for reducing implementation complexity and power consumption may be employed by the UE 115 while supporting SBFD operation. For example, the UE 115 may indicate to the network entity 105 whether to operate in a SBFD mode or a non-SBFD mode. In some examples, a UE 115 may receive first information that is indicative of a SBFD configuration. The UE 115 may receive second information that is indicative of a TDD configuration. The UE 115 may transmit an indication that indicates operation of the UE 115 in an SBFD mode or in a non-SBFD mode. The operation of the UE 115 in the SBFD mode is in accordance with the SBFD configuration, and the operation of the UE 115 in the non-SBFD mode is in accordance with the TDD configuration. If the UE 115 indicates the SBFD mode, the UE 115 may receive third information that schedules an uplink or downlink transmission in an SBFD resource in accordance with the SBFD configuration. If the UE 115 indicates the non-SBFD mode, the UE 115 may receive third information that schedules an uplink or downlink transmission in a resource in accordance with the TDD configuration. In some examples, the transmission of the indication may occur as part of an initial access procedure. In some cases, the transmission of the indication occurs during an RRC connected mode, RRC idle mode, or RRC inactive mode. In some cases, the transmission of the indication may occur as part of a random access procedure.

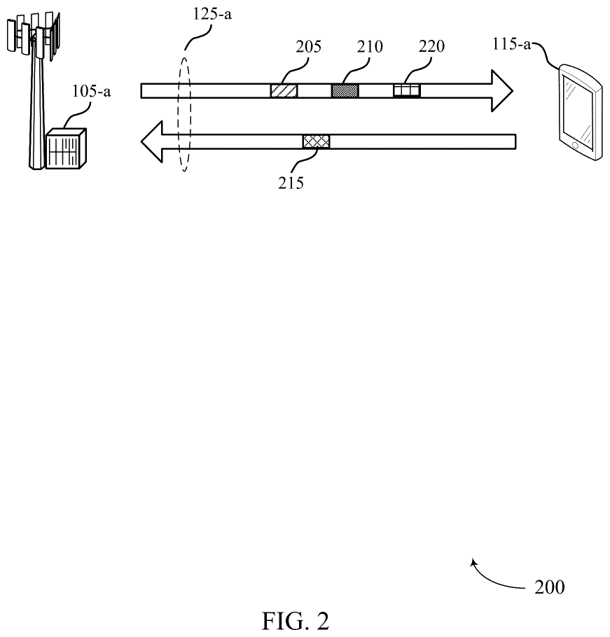

FIG. 2 shows an example of a wireless communications system 200 that supports techniques for SBFD operation in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the network entity 105-a may transmit downlink signals (e.g., downlink transmissions), such as downlink control signaling and downlink data signals, to the UE 115-a using the communication link 125-a, and the UE 115-a may transmit uplink signals (e.g., uplink transmissions), such as uplink control signaling and uplink data signals, to the network entity 105-a using the communication link 125-a.

In some examples, the wireless communication system 200 may support TDD, and the network entity 105-a and the UE 115-a may perform wireless communication (e.g., downlink communication, uplink communication) on a same frequency resource and over one or multiple different time resources (e.g., symbols, slots). In TDD, allocation of a limited duration for the uplink communications may result in reduced coverage, increased latency and reduced capacity. In some cases, the wireless communication system 200 may support SBFD. In SBFD, the wireless devices may perform downlink communication over a downlink subband and uplink communication over an uplink subband, and the downlink subband and the uplink subband may be nonoverlapping. In SBFD, a network entity may configure one or more SBFD slots of a component carrier with both uplink resources (e.g., one or more uplink sub-bands) and downlink resources (e.g., one or more downlink sub-bands).

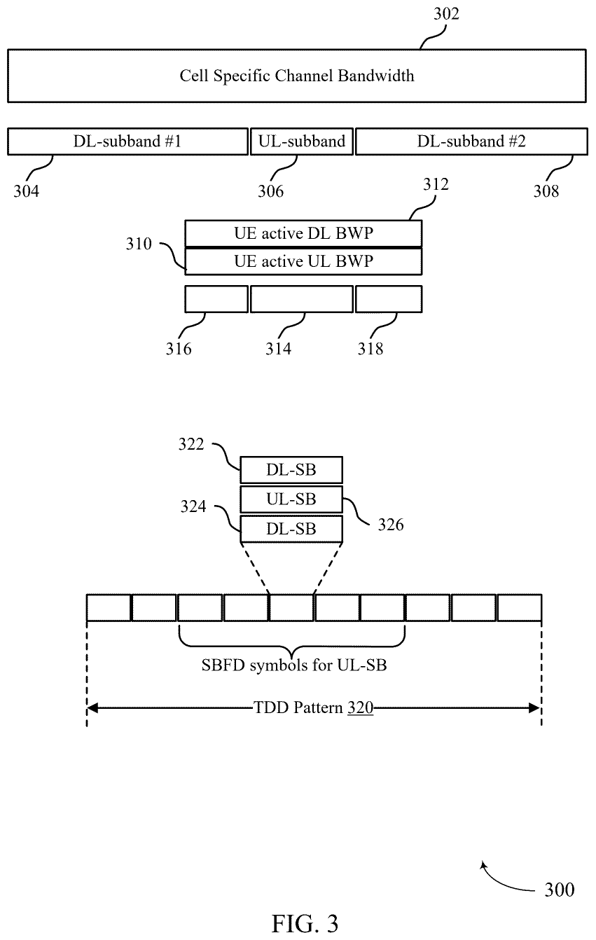

FIG. 3 shows an example of a resource diagram 300 that supports techniques for SBFD operation in accordance with one or more aspects of the present disclosure. The resource diagram 300 may implement aspects of or may be implemented by aspects of the wireless communications system 100 and wireless communications system 200.

The resource diagram 300 illustrates a cell specific channel bandwidth 302. The cell specific channel bandwidth 302 may be divided into a downlink subband 304, an uplink subband 306, and a downlink subband 308. The uplink subband frequency resources within an active uplink BWP 310 may be called uplink usable physical resource blocks (PRBs), and the downlink subband(s) frequency resources within an active downlink BWP 312 may be called downlink usable PRBs. In some examples, uplink usable PRBs 314 may be determined as an intersection between the cell-specific uplink subband 306 and the active uplink BWP 310 in SBFD symbols, and the downlink usable PRBs (e.g., downlink usable PRB 316 and downlink usable PRB 318) may be determined as an intersection between cell-specific downlink DL subbands (e.g., downlink subband 304 and downlink subband 308) and the active downlink BWP 312 in SBFD symbols. In some cases, uplink usable PRBs 314 and downlink usable PRBs (e.g., downlink usable PRB 316 and downlink usable PRB 318) may be explicitly configured within active uplink BWP 310 and active downlink BWP 312 in SBFD symbols.

The resource diagram 300 illustrates a TDD pattern 320. The SBFD time location may be semi-statically indicated by the network entity 105-a. A slot of the TDD pattern may include SBFD symbols and non-SBFD symbols. The SBFD symbol may include a downlink subband 322, an uplink subband 326, and a downlink subband 324. For the UE 115-a in an RRC connected mode, SBFD subband time locations are configured within a period. In some examples, the period may be the same as the TDD-UL-DL pattern period configured by dl-UL-TransmissionPeriodicity in TDD-UL-DL-ConfigCommon. In some cases, the period may be an integer multiple of TDD-UL-DL pattern period configured by dl-UL-TransmissionPeriodicity in TDD-UL-DL-ConfigCommon.

In some examples, the network entity 105-a may signal a cell specific configuration for SBFD operation. Three different types of UEs may in an SBFD cell: a Type I UE, a Type II UE, and a Type III UE. The Type I UE may be a legacy UE that may not receive and process SBFD configuration (e.g., may not decode the corresponding system information block (SIB) with the SBFD configuration). The Type II UE may receive and process the SBFD configuration, but the Type II UE may not operate in the SBFD mode (e.g., may not transmit or receive during SBFD slots or symbols based on SBFD configuration). The Type II UE may be aware of the SBFD configuration of the cell, but the Type II UE operates as a legacy UE. The Type III UE may receive and process the SBFD configuration and may operate in the SBFD mode (e.g., can transmit or receive during SBFD slots or symbols based on the SBFD configuration).

In some cases, the UE 115-a may support SBFD operation, and the UE 115-a may communicate using both uplink resources and downlink resources in an SBFD slot. Support of SBFD and SBFD operation may include additional implementation complexity and power consumption for the UE 115-a. For example, SBFD operation may include wide BWP operation that may result in additional power consumption by the UE 115-a and decoupled BWP operation that may use additional hardware and separate radio frequency architecture. The UE operating in the SBFD mode may have frequent BWP switches and fast or frequent uplink to downlink switches and downlink to uplink switches. In some cases, the SBFD mode may include baseband enhancements, such as receiving non-contiguous channel state information reference signals (CSI-RS) and physical downlink shared channel (PDSCH) transmission across two downlink subbands and transmission or reception collision handling resolutions in SBFD. The SBFD mode operation may support higher spectrum efficiency, higher uplink data transmission, longer uplink coverage and lower latency than the non-SBFD mode.

In some cases, the UE 115-a may not have a high quantity of uplink data and may operate under good serving cell conditions most of the time. Operating in the SBFD mode may lead to unnecessary UE implementation complexity and power consumption if the UE operates in the SBFD mode during the configured SBFD slots or symbols. Techniques for SBFD operation may be employed for reducing implementation complexity and power consumption by the UE 115-a. For example, the UE 115-a may indicate to the network entity 105-a whether to operate in a SBFD mode or a non-SBFD mode. If the UE 115-a indicates the SBFD mode, the network entity 105-a may schedule uplink or downlink transmissions in the SBFD slots or symbols based on the SBFD configuration. If the UE 115-a indicates the non-SBFD mode, the UE 115-a may not be expected to transmit or receive based on the SBFD configuration during the SBFD slots or symbols, and the UE 115-a may perform uplink or downlink operation based on the configured TDD pattern with downlink, uplink, or flexible slots or symbols.

Referring to FIG. 2, the UE 115-a may receive first information 205 that is indicative of a SBFD configuration, and the UE 115-a may receive second information 210 that is indicative of a TDD configuration. The UE 115-a may transmit an indication 215 that indicates operation of the UE 115-a in an SBFD mode or in a non-SBFD mode. The operation of the UE 115-a in the SBFD mode may be in accordance with the SBFD configuration, and the operation of the UE 115-a in the non-SBFD mode is in accordance with the TDD configuration. If the UE 115-a transmits the indication of the SBFD mode, the UE 115-a may receive third information 220 that schedules an uplink or downlink transmission in an SBFD resource in accordance with the SBFD configuration. If the UE 115-a transmits the indication of the non-SBFD mode, the UE 115-b may receive third information 220 information that schedules an uplink or downlink transmission in a resource in accordance with the TDD configuration.

In some examples, the UE 115-a may indicate the SBFD mode or non-SBFD mode during an initial access procedure. The UE 115-a may indicate the non-SBFD mode depending on the SBFD configuration (e.g., uplink or downlink subband configuration of the cell known from the SIB), the supported uplink or downlink BWPs not being a good match for the SBFD configuration, an unsupported quantity of BWP switching during a period, an unsupported quantity of uplink to downlink switching or downlink to uplink switching during a period.

In some cases, the UE 115-a may indicate the SBFD mode or non-SBFD mode during the RRC connected mode. The UE 115-a may indicate the non-SBFD mode depending on a quantity of BWP switching or quantity of uplink to downlink switching or downlink to uplink switching (e.g., the UE 115-a may encounter overheating due to the quantity of switching). The UE 115-a may indicate the non-SBFD mode depending on the UE 115-a encountering significant performance degradation due to cross link interference (CLI). The UE 115-a may indicate the non-SBFD mode depending on the UE 115-a not having much data for uplink transmission or the UE 115-a is operating under good cell conditions. The UE 115-a may indicate the non-SBFD mode depending on the UE 115-a having unsupported BWP configurations for the SBFD configuration of the cell. The UE 115-a may subsequently indicate to the network entity 105-a the SBFD mode depending on one or more of these indicated scenarios no longer being valid.

In some examples, the UE 115-a may indicate the SBFD mode or non-SBFD mode during an RRC inactive mode or an RRC idle mode. The UE 115-a may use a UE capability signaling or feature support signaling to indicate the SBFD mode or non-SBFD mode to the network entity 105-a.

In some cases, during an initial access procedure, the UE 115-a may indicate the SBFD mode or non-SBFD mode during a random access channel (RACH) transmission. A subset of RACH occasions or preambles may be defined to indicate the SBFD mode or non-SBFD mode. If the network entity 105-a receives the indication of the SBFD mode via the RACH occasion or preamble, the network entity 105-a may schedule a random access transmission (e.g., message 2 (Msg2), message 3 (Msg3), message 4 (Msg4), or combination thereof) based on the SBFD configuration. For example, if the UE 115-a indicates the SBFD mode, the network entity 105-a may schedule Msg3 in the SBFD slots or symbols. If the UE 115-a indicates the non-SBFD mode, the network entity 105-a may schedule Msg3 during the uplink slots or symbols. If the UE 115-a indicates the non-SBFD mode, the UE 115-a may provide additional information to indicate a reason for the non-SBFD mode. Predetermined reasons may be identified and defined, and the UE 115-a may indicate one of the reasons as part of the RRC message (e.g., Msg3 or Msg5 during the RACH procedure). Providing the reason for the non-SBFD mode may assist the network entity 105-a to update the SBFD configuration and operation to improve network performance.

In some examples, in the RRC connect mode, the UE 115-a may indicate the SBFD mode or non-SBFD mode using UE assistance information (UAI) as part of RRC qsignaling or MAC control element based signaling. The UAI transmissions may be triggered based on one or more events, such as unsupported or supported BWP for SBFD after a BWP switch, change in cell conditions (e.g., cell edge or not at cell edge and low or high mobility), change in uplink data buffer (e.g., higher uplink data buffer may lead to enable SBFD mode operation). In some cases, the UE 115-a may indicate the one or more events that triggered the UAI transmission to the network entity 105-a.

In some cases, the SBFD time configuration may be cell specific. Not all UEs may operate in SBFD mode for all symbols or slots, and cell-center UE may have good uplink coverage and may utilize less uplink subband (SBFD symbols) and more downlink symbols. In some examples, the UE 115-a may indicate to the network entity 105-a a recommended setting of the SBFD time pattern (e.g., SBFD period).

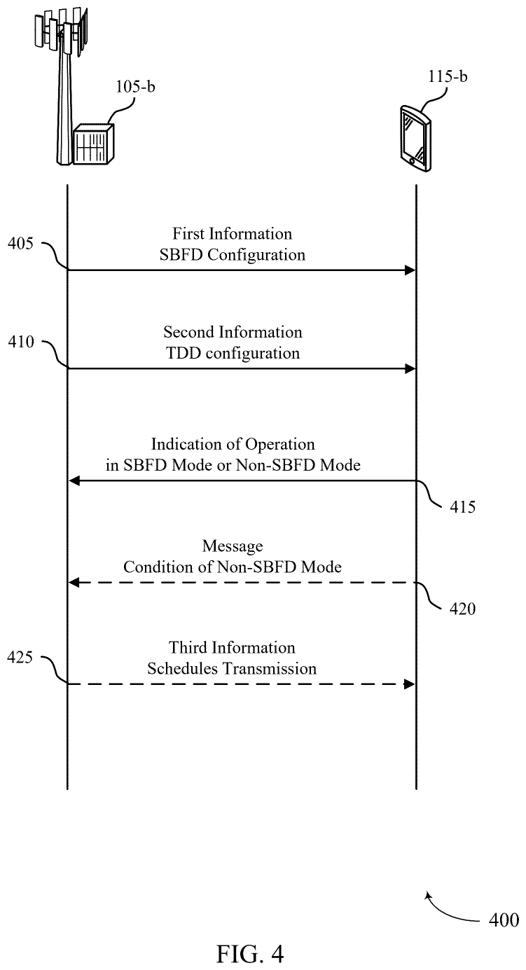

FIG. 4 shows an example of a process flow 400 that supports techniques for SBFD operation in accordance with one or more aspects of the present disclosure. In some examples, the process flow 400 may implement or be implemented by aspects of the wireless communications systems 100 and 200 as described with reference to FIGS. 1 and 2, respectively. For example, the process flow 400 may be implemented by a network entity 105-b, which may be an example of the network entities 105 as described with reference to FIGS. 1 and 2. The process flow 400 may be implemented by a UE 115-b, which may be an example of the UEs as described with reference to FIGS. 1 and 2.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 405, the UE 115-b may receive first information that is indicative of a SBFD configuration.

At 410, the UE 115-b may receive second information that is indicative of a TDD configuration.

At 415, the UE 115-b may transmit an indication that indicates operation of the network entity in an SBFD mode or in a non-SBFD mode. The operation of the UE 115-b in the SBFD mode may be in accordance with the SBFD configuration, and the operation of the UE 115-b in the non-SBFD mode is in accordance with the TDD configuration.

In some examples, the transmission of the indication may occur as part of an initial access procedure. The indication may be indicative of operation of the UE 115-b in the non-SBFD mode based on participation of the UE 115-b in the initial access procedure and based on the SBFD configuration, a first quantity of bandwidth part switching supported by the UE 115-b, a second quantity of downlink to uplink switching or uplink to downlink switching supported by the UE 115-b, or a combination thereof.

In some examples, the transmission of the indication may occur while the UE 115-b is in a RRC connected mode. The indication may be indicative of operation of the UE 115-b in the non-SBFD mode based on the UE 115-b being in the RRC connected mode and based on a first quantity of bandwidth part switching supported by the UE 115-b, a second quantity of downlink to uplink switching or uplink to downlink switching supported by the UE 115-b, a third quantity of cross link interference experienced by the UE 115-b, a fourth quantity of uplink data available for transmission, a bandwidth part configuration of the SBFD configuration supported by the UE 115-b, or a combination thereof. In some examples, the transmission of the indication may occur as part of a UE assistance information transmission. The indication may be indicative of operation of the UE 115-b in the non-SBFD mode based on participation of the UE 115-b in transmission of the UE assistance information transmission and based on one or more events of a bandwidth part of the SBFD configuration after a bandwidth part switch supported by the UE 115-b, a change in cell conditions associated with the UE 115-b, or a change in a quantity of uplink data available for transmission. In some cases, the indication may indicate the one or more events.

In some examples, the transmission of the indication may occur while the UE 115-b is in a RRC inactive mode or a RRC idle mode. The transmission of the indication may occur as part of capability signaling or feature support signaling.

In some cases, the transmission of the indication may occur as part of a random access procedure. The indication may include a random access preamble or the indication may be associated with a random access occasion.

At 420, the UE 115-b may transmit a message, subsequent to the indication, that indicates a condition associated with the non-SBFD mode. In some cases, the UE 115-b may transmit a message, subsequent to the first information, that indicates a SBFD period associated with the SBFD configuration.

At 425, the UE 115-b may receive, responsive to transmission of the indication, third information that schedules an uplink or downlink transmission in an SBFD resource in accordance with the SBFD configuration where the indication is indicative of operation of the UE 115-b in the SBFD mode. In some examples, the UE 115-b may receive, responsive to transmission of the indication, third information that schedules an uplink or downlink transmission in a resource in accordance with the TDD configuration where indication is indicative of operation of the UE 115-b in the non-SBFD mode.

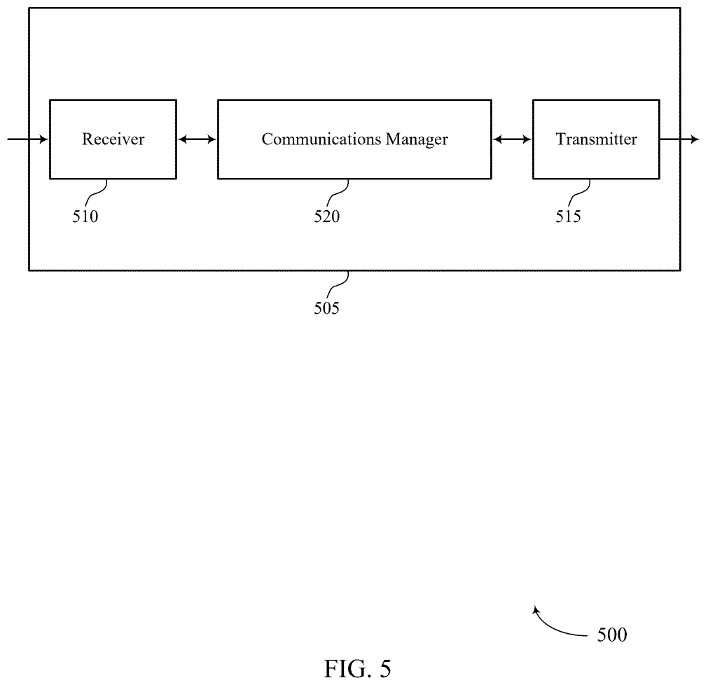

FIG. 5 shows a block diagram 500 of a device 505 that supports techniques for SBFD operation in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for SBFD operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for SBFD operation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for SBFD operation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first information that is indicative of a SBFD configuration. The communications manager 520 is capable of, configured to, or operable to support a means for receiving second information that is indicative of a TDD configuration. The communications manager 520 is capable of, configured to, or operable to support a means for transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

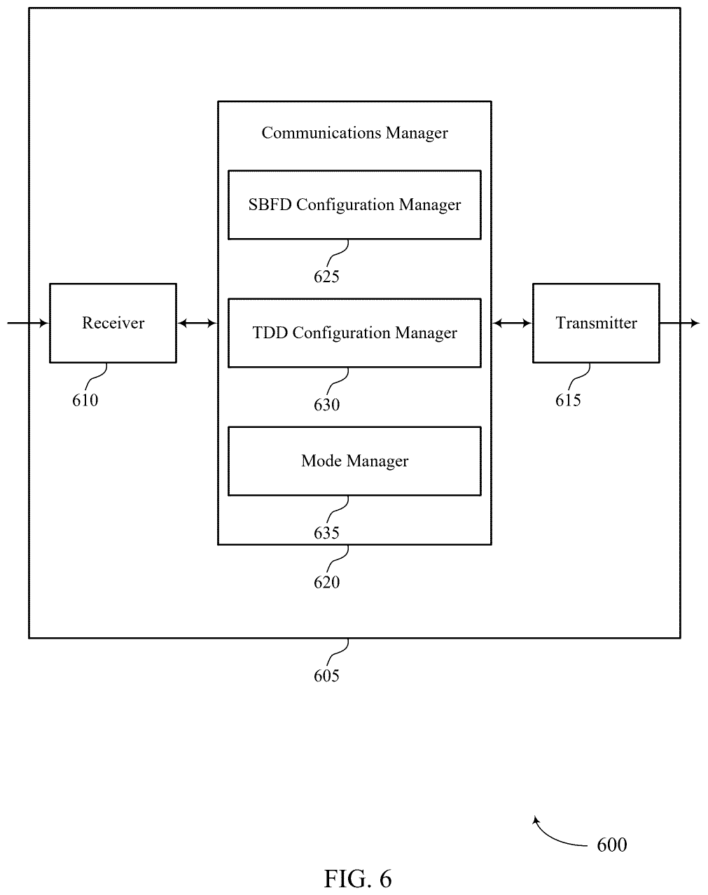

FIG. 6 shows a block diagram 600 of a device 605 that supports techniques for SBFD operation in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for SBFD operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for SBFD operation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for SBFD operation as described herein. For example, the communications manager 620 may include an SBFD configuration manager 625, a TDD configuration manager 630, a mode manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SBFD configuration manager 625 is capable of, configured to, or operable to support a means for receiving first information that is indicative of a SBFD configuration. The TDD configuration manager 630 is capable of, configured to, or operable to support a means for receiving second information that is indicative of a TDD configuration. The mode manager 635 is capable of, configured to, or operable to support a means for transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

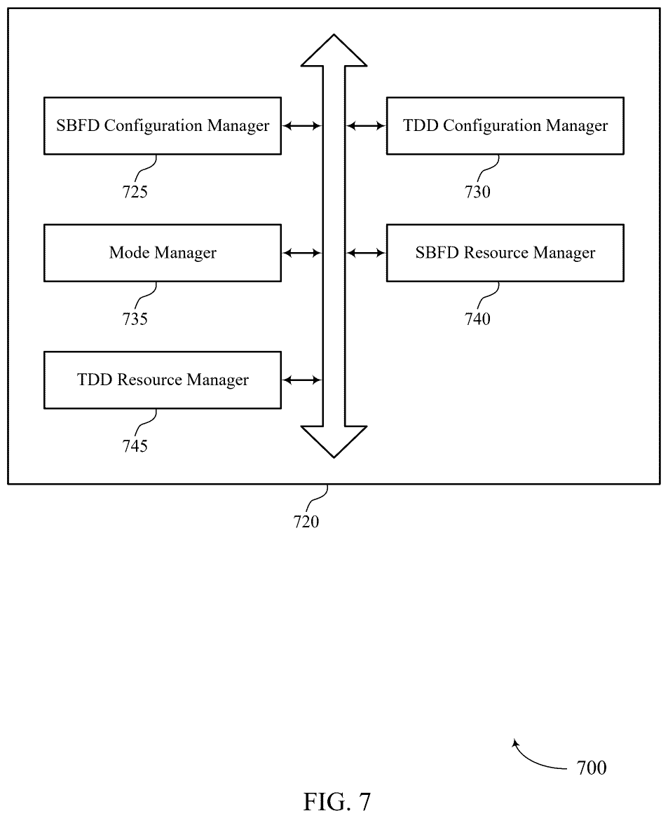

FIG. 7 shows a block diagram 700 of a communications manager 720 that supports techniques for SBFD operation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for SBFD operation as described herein. For example, the communications manager 720 may include an SBFD configuration manager 725, a TDD configuration manager 730, a mode manager 735, an SBFD resource manager 740, a TDD resource manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SBFD configuration manager 725 is capable of, configured to, or operable to support a means for receiving first information that is indicative of a SBFD configuration. The TDD configuration manager 730 is capable of, configured to, or operable to support a means for receiving second information that is indicative of a TDD configuration. The mode manager 735 is capable of, configured to, or operable to support a means for transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

In some examples, the SBFD resource manager 740 is capable of, configured to, or operable to support a means for receiving, responsive to transmission of the indication, third information that schedules an uplink or downlink transmission in an SBFD resource in accordance with the SBFD configuration, where the indication is indicative of operation of the network entity in the SBFD mode.

In some examples, the TDD resource manager 745 is capable of, configured to, or operable to support a means for receiving, responsive to transmission of the indication, third information that schedules an uplink or downlink transmission in a resource in accordance with the TDD configuration, where the indication is indicative of operation of the network entity in the non-SBFD mode.

In some examples, transmission of the indication occurs as part of an initial access procedure.

In some examples, the indication is indicative of operation of the network entity in the non-SBFD mode based on participation of the network entity in the initial access procedure and based on the SBFD configuration, a first quantity of bandwidth part switching supported by the network entity, a second quantity of downlink to uplink switching or uplink to downlink switching supported by the network entity, or a combination thereof.

In some examples, transmission of the indication occurs while the network entity is in a RRC connected mode.

In some examples, the indication is indicative of operation of the network entity in the non-SBFD mode based on the network entity being in the RRC connected mode and based on a first quantity of bandwidth part switching supported by the network entity, a second quantity of downlink to uplink switching or uplink to downlink switching supported by the network entity, a third quantity of cross link interference experienced by the network entity, a fourth quantity of uplink data available for transmission, a bandwidth part configuration of the SBFD configuration supported by the network entity, or a combination thereof.

In some examples, the transmission of the indication occurs as part of a UE assistance information transmission.

In some examples, the indication is indicative of operation of the network entity in the non-SBFD mode based on participation of the network entity in transmission of the UE assistance information transmission and based on one or more events of a bandwidth part of the SBFD configuration after a bandwidth part switch supported by the network entity, a change in cell conditions associated with the network entity, or a change in a quantity of uplink data available for transmission.

In some examples, the indication indicates the one or more events.

In some examples, transmission of the indication occurs while the network entity is in a RRC inactive mode or a RRC idle mode.

In some examples, the transmission of the indication occurs as part of capability signaling or feature support signaling.

In some examples, transmission of the indication occurs as part of a random access procedure.

In some examples, the indication includes a random access preamble or the indication is associated with a random access occasion.

In some examples, the mode manager 735 is capable of, configured to, or operable to support a means for transmitting a message, subsequent to the indication, that indicates a condition associated with the non-SBFD mode.

In some examples, the SBFD configuration manager 725 is capable of, configured to, or operable to support a means for transmitting a message, subsequent to the first information, that indicates a SBFD period associated with the SBFD configuration.

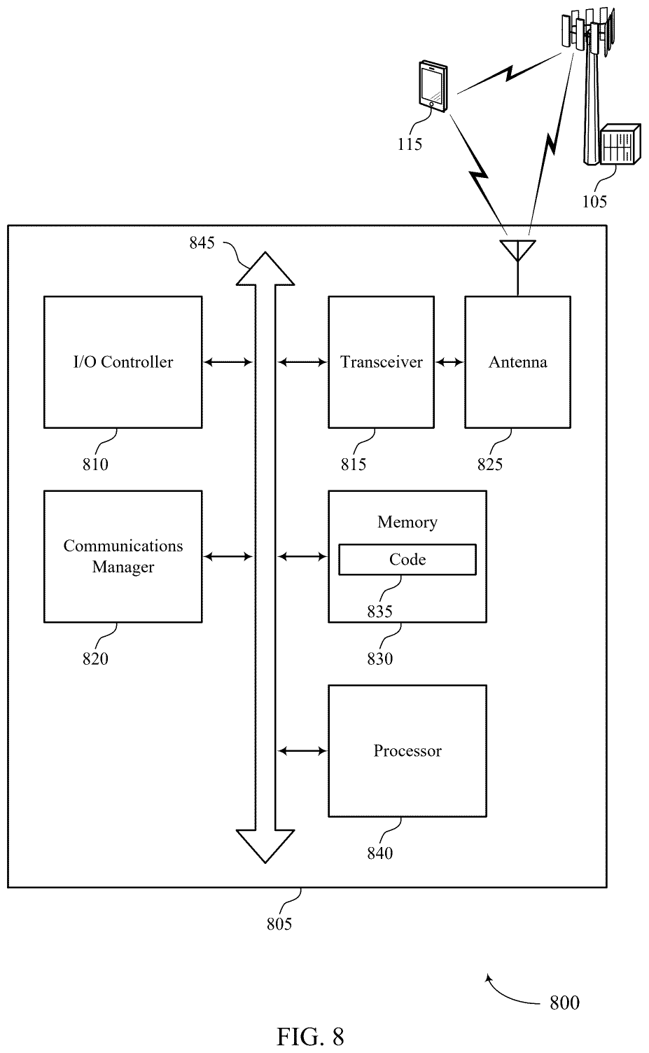

FIG. 8 shows a diagram of a system 800 including a device 805 that supports techniques for SBFD operation in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for SBFD operation). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first information that is indicative of a SBFD configuration. The communications manager 820 is capable of, configured to, or operable to support a means for receiving second information that is indicative of a TDD configuration. The communications manager 820 is capable of, configured to, or operable to support a means for transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration.

By including or configuring the communications manager 820 in accordance with examples as described herein, the device 805 may support techniques for improved user experience related to reduced processing, reduced power consumption, more efficient utilization of communication resources, improved coordination between devices, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for SBFD operation as described herein, or the at least one processor 840 and the at least one memory 830 may be otherwise configured to, individually or collectively, perform or support such operations.

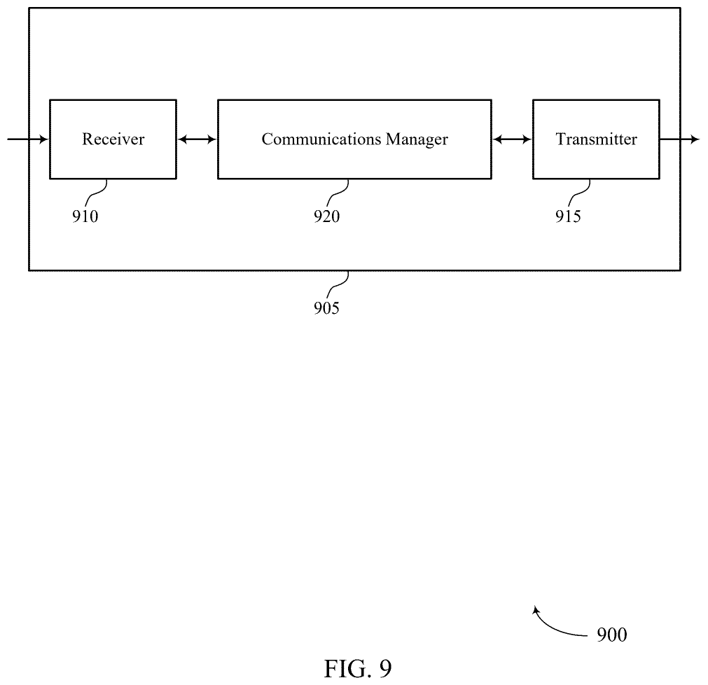

FIG. 9 shows a block diagram 900 of a device 905 that supports techniques for SBFD operation in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for SBFD operation as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting first information that is indicative of a SBFD configuration. The communications manager 920 is capable of, configured to, or operable to support a means for outputting second information that is indicative of a TDD configuration. The communications manager 920 is capable of, configured to, or operable to support a means for obtaining an indication that indicates operation of a second network entity in an SBFD mode or in a non-SBFD mode, where operation of the second network entity in the SBFD mode is in accordance with the SBFD configuration, and where operation of the second network entity in the non-SBFD mode is in accordance with the TDD configuration.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

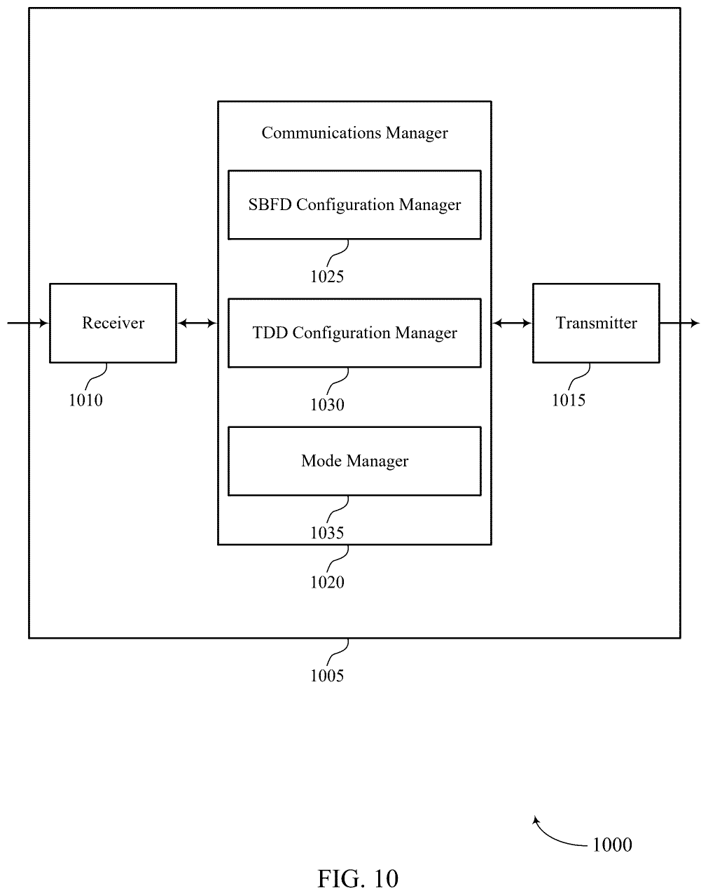

FIG. 10 shows a block diagram 1000 of a device 1005 that supports techniques for SBFD operation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for SBFD operation as described herein. For example, the communications manager 1020 may include an SBFD configuration manager 1025, a TDD configuration manager 1030, a mode manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SBFD configuration manager 1025 is capable of, configured to, or operable to support a means for outputting first information that is indicative of a SBFD configuration. The TDD configuration manager 1030 is capable of, configured to, or operable to support a means for outputting second information that is indicative of a TDD configuration. The mode manager 1035 is capable of, configured to, or operable to support a means for obtaining an indication that indicates operation of a second network entity in an SBFD mode or in a non-SBFD mode, where operation of the second network entity in the SBFD mode is in accordance with the SBFD configuration, and where operation of the second network entity in the non-SBFD mode is in accordance with the TDD configuration.

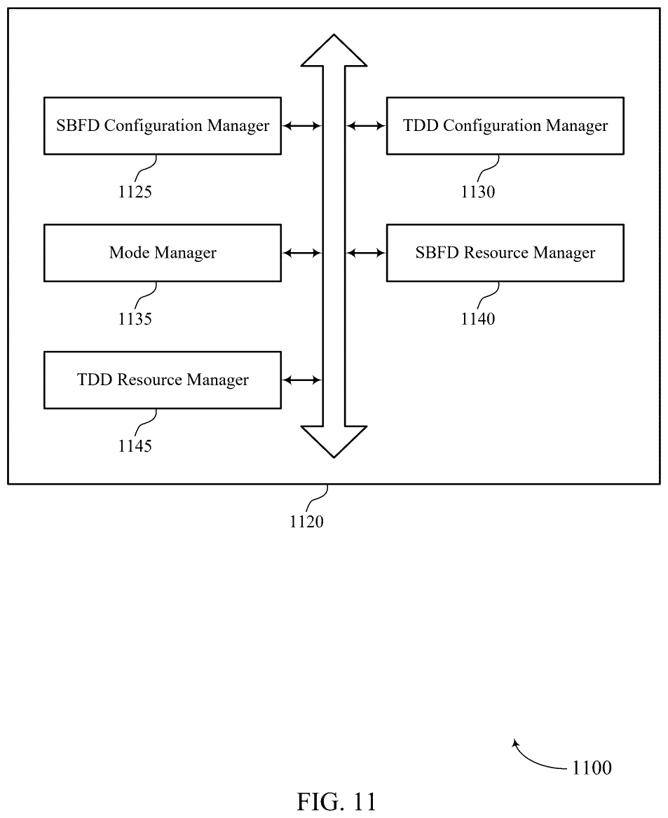

FIG. 11 shows a block diagram 1100 of a communications manager 1120 that supports techniques for SBFD operation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for SBFD operation as described herein. For example, the communications manager 1120 may include an SBFD configuration manager 1125, a TDD configuration manager 1130, a mode manager 1135, an SBFD resource manager 1140, a TDD resource manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The SBFD configuration manager 1125 is capable of, configured to, or operable to support a means for outputting first information that is indicative of a SBFD configuration. The TDD configuration manager 1130 is capable of, configured to, or operable to support a means for outputting second information that is indicative of a TDD configuration. The mode manager 1135 is capable of, configured to, or operable to support a means for obtaining an indication that indicates operation of a second network entity in an SBFD mode or in a non-SBFD mode, where operation of the second network entity in the SBFD mode is in accordance with the SBFD configuration, and where operation of the second network entity in the non-SBFD mode is in accordance with the TDD configuration.

In some examples, the SBFD resource manager 1140 is capable of, configured to, or operable to support a means for outputting, responsive to reception of the indication, third information that schedules an uplink or downlink transmission in an SBFD resource in accordance with the SBFD configuration, where the indication is indicative of operation of the second network entity in the SBFD mode.

In some examples, the TDD resource manager 1145 is capable of, configured to, or operable to support a means for outputting, responsive to reception of the indication, third information that schedules an uplink or downlink transmission in a resource in accordance with the TDD configuration, where the indication is indicative of operation of the network entity in the non-SBFD mode.

In some examples, reception of the indication occurs as part of an initial access procedure.

In some examples, reception of the indication occurs as part of a RRC connected mode.

In some examples, the reception of the indication occurs as part of a UE assistance information transmission.

In some examples, reception of the indication occurs as part of a RRC inactive mode or a RRC idle mode.

In some examples, the reception of the indication occurs as part of a capability signaling or a feature support signaling.

In some examples, reception of the indication occurs as part of a random access procedure.

In some examples, the indication includes a random access preamble or the indication is associated with a random access occasion.

In some examples, the SBFD resource manager 1140 is capable of, configured to, or operable to support a means for outputting, responsive to transmission of the indication, third information that schedules an uplink or downlink transmission in an SBFD resource in accordance with the SBFD configuration, where the indication is indicative of operation of the second network entity in the SBFD mode.

In some examples, the mode manager 1135 is capable of, configured to, or operable to support a means for obtaining first signaling, subsequent to the indication, that indicates a condition associated with the non-SBFD mode. In some examples, the SBFD configuration manager 1125 is capable of, configured to, or operable to support a means for outputting second signaling, responsive to the first signaling, that indicates a second SBFD configuration based on the condition.

In some examples, the SBFD configuration manager 1125 is capable of, configured to, or operable to support a means for obtaining a message, subsequent to the first information, that indicates a SBFD period associated with the SBFD configuration.

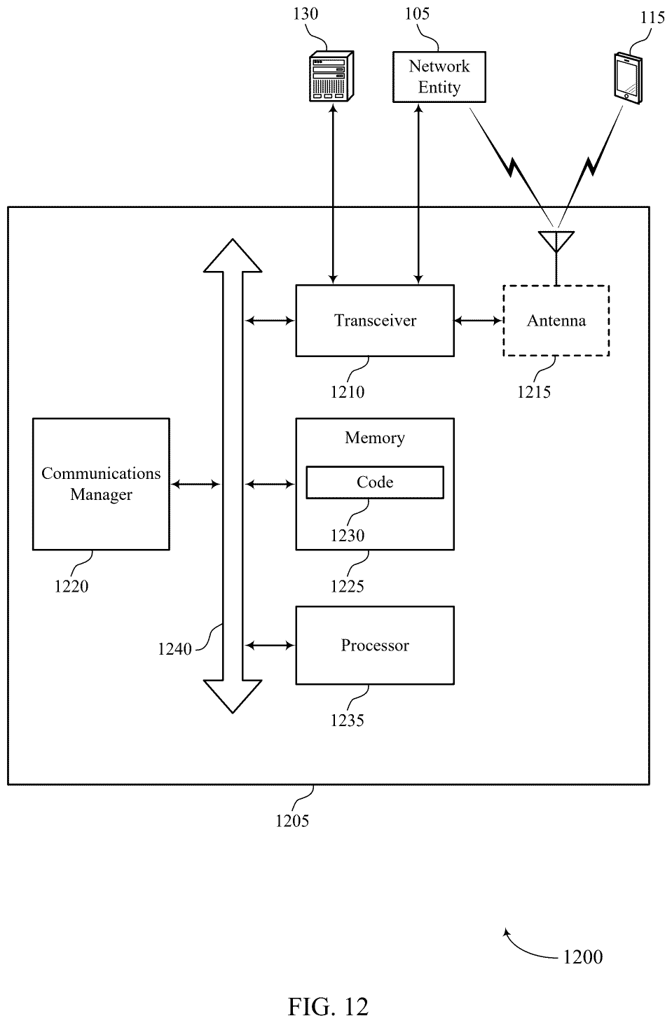

FIG. 12 shows a diagram of a system 1200 including a device 1205 that supports techniques for SBFD operation in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for SBFD operation). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting first information that is indicative of a SBFD configuration. The communications manager 1220 is capable of, configured to, or operable to support a means for outputting second information that is indicative of a TDD configuration. The communications manager 1220 is capable of, configured to, or operable to support a means for obtaining an indication that indicates operation of a second network entity in an SBFD mode or in a non-SBFD mode, where operation of the second network entity in the SBFD mode is in accordance with the SBFD configuration, and where operation of the second network entity in the non-SBFD mode is in accordance with the TDD configuration.

By including or configuring the communications manager 1220 in accordance with examples as described herein, the device 1205 may support techniques for improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for SBFD operation as described herein, or the at least one processor 1235 and the at least one memory 1225 may be otherwise configured to, individually or collectively, perform or support such operations.

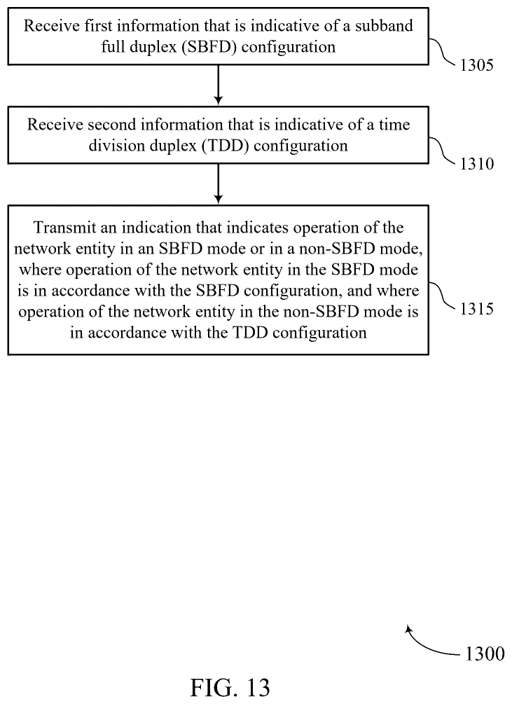

FIG. 13 shows a flowchart illustrating a method 1300 that supports techniques for SBFD operation in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first information that is indicative of a SBFD configuration. The operations of 1305 may be performed in accordance with examples as disclosed herein. In some examples, aspects of the operations of 1305 may be performed by an SBFD configuration manager 725 as described with reference to FIG. 7.

At 1310, the method may include receiving second information that is indicative of a time division duplex (TDD) configuration. The operations of 1310 may be performed in accordance with examples as disclosed herein. In some examples, aspects of the operations of 1310 may be performed by a TDD configuration manager 730 as described with reference to FIG. 7.

At 1315, the method may include transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration. The operations of 1315 may be performed in accordance with examples as disclosed herein. In some examples, aspects of the operations of 1315 may be performed by a mode manager 735 as described with reference to FIG. 7.

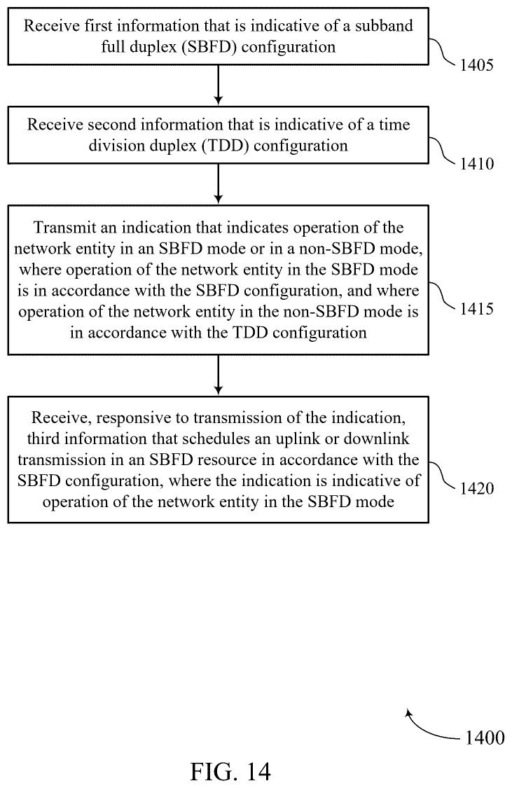

FIG. 14 shows a flowchart illustrating a method 1400 that supports techniques for SBFD operation in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving first information that is indicative of a SBFD configuration. The operations of 1405 may be performed in accordance with examples as disclosed herein. In some examples, aspects of the operations of 1405 may be performed by an SBFD configuration manager 725 as described with reference to FIG. 7.

At 1410, the method may include receiving second information that is indicative of a TDD configuration. The operations of 1410 may be performed in accordance with examples as disclosed herein. In some examples, aspects of the operations of 1410 may be performed by a TDD configuration manager 730 as described with reference to FIG. 7.

At 1415, the method may include transmitting an indication that indicates operation of the network entity in an SBFD mode or in a non-SBFD mode, where operation of the network entity in the SBFD mode is in accordance with the SBFD configuration, and where operation of the network entity in the non-SBFD mode is in accordance with the TDD configuration. The operations of 1415 may be performed in accordance with examples as disclosed herein. In some examples, aspects of the operations of 1415 may be performed by a mode manager 735 as described with reference to FIG. 7.

At 1420, the method may include receiving, responsive to transmission of the indication, third information that schedules an uplink or downlink transmission in an SBFD resource in accordance with the SBFD configuration, where the indication is indicative of operation of the network entity in the SBFD mode. The operations of 1420 may be performed in accordance with examples as disclosed herein. In some examples, aspects of the operations of 1420 may be performed by an SBFD resource manager 740 as described with reference to FIG. 7.

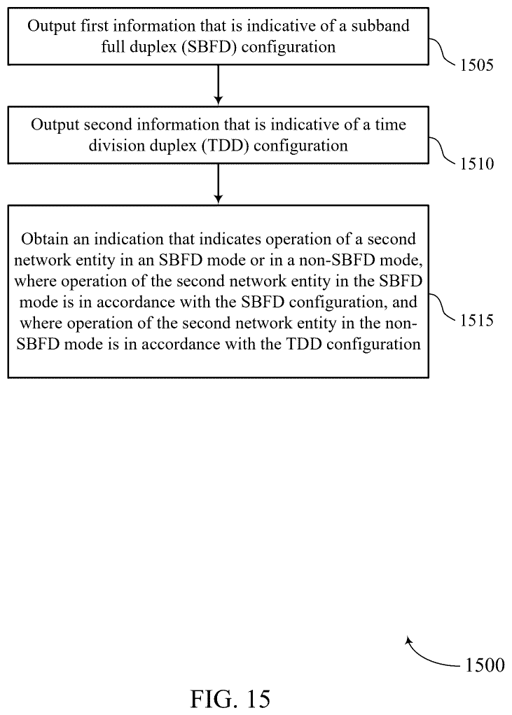

FIG. 15 shows a flowchart illustrating a method 1500 that supports techniques for SBFD operation in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting first information that is indicative of a SBFD configuration. The operations of 1505 may be performed in accordance with examples as disclosed herein. In some examples, aspects of the operations of 1505 may be performed by an SBFD configuration manager 1125 as described with reference to FIG. 11.

At 1510, the method may include outputting second information that is indicative of a TDD configuration. The operations of 1510 may be performed in accordance with examples as disclosed herein. In some examples, aspects of the operations of 1510 may be performed by a TDD configuration manager 1130 as described with reference to FIG. 11.

At 1515, the method may include obtaining an indication that indicates operation of a second network entity in an SBFD mode or in a non-SBFD mode, where operation of the second network entity in the SBFD mode is in accordance with the SBFD configuration, and where operation of the second network entity in the non-SBFD mode is in accordance with the TDD configuration. The operations of 1515 may be performed in accordance with examples as disclosed herein. In some examples, aspects of the operations of 1515 may be performed by a mode manager 1135 as described with reference to FIG. 11.

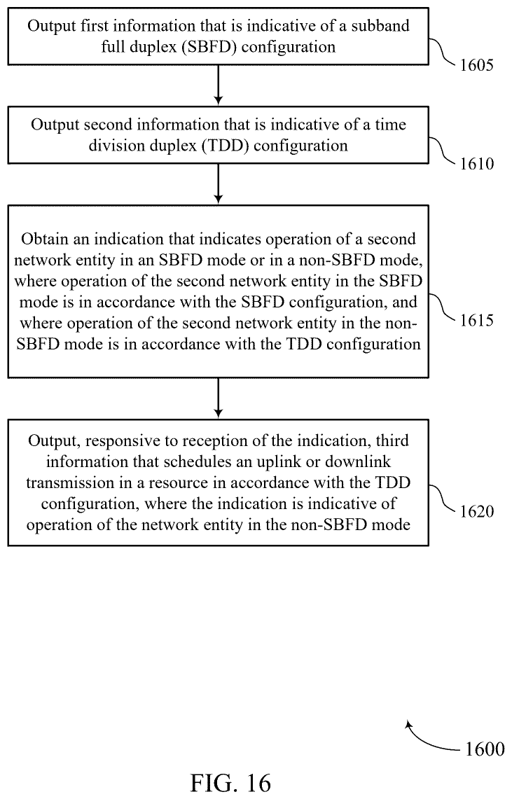

FIG. 16 shows a flowchart illustrating a method 1600 that supports techniques for SBFD operation in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting first information that is indicative of a SBFD configuration. The operations of 1605 may be performed in accordance with examples as disclosed herein. In some examples, aspects of the operations of 1605 may be performed by an SBFD configuration manager 1125 as described with reference to FIG. 11.

At 1610, the method may include outputting second information that is indicative of a TDD configuration. The operations of 1610 may be performed in accordance with examples as disclosed herein. In some examples, aspects of the operations of 1610 may be performed by a TDD configuration manager 1130 as described with reference to FIG. 11.

At 1615, the method may include obtaining an indication that indicates operation of a second network entity in an SBFD mode or in a non-SBFD mode, where operation of the second network entity in the SBFD mode is in accordance with the SBFD configuration, and where operation of the second network entity in the non-SBFD mode is in accordance with the TDD configuration. The operations of 1615 may be performed in accordance with examples as disclosed herein. In some examples, aspects of the operations of 1615 may be performed by a mode manager 1135 as described with reference to FIG. 11.

At 1620, the method may include outputting, responsive to reception of the indication, third information that schedules an uplink or downlink transmission in a resource in accordance with the TDD configuration, where the indication is indicative of operation of the network entity in the non-SBFD mode. The operations of 1620 may be performed in accordance with examples as disclosed herein. In some examples, aspects of the operations of 1620 may be performed by a TDD resource manager 1145 as described with reference to FIG. 11.

The following provides an overview of aspects of the present disclosure:

Aspect 1: A method for wireless communications by a UE, comprising: receiving first information that is indicative of a subband full duplex (SBFD) configuration; receiving second information that is indicative of a time division duplex (TDD) configuration; and transmitting an indication that indicates operation of the network entity in an SBFD mode or in a non-SBFD mode, wherein operation of the network entity in the SBFD mode is in accordance with the SBFD configuration, and wherein operation of the network entity in the non-SBFD mode is in accordance with the TDD configuration.

Aspect 2: The method of aspect 1, further comprising: receiving, responsive to transmission of the indication, third information that schedules an uplink or downlink transmission in an SBFD resource in accordance with the SBFD configuration, wherein the indication is indicative of operation of the network entity in the SBFD mode.

Aspect 3: The method of aspects 1, further comprising: receiving, responsive to transmission of the indication, third information that schedules an uplink or downlink transmission in a resource in accordance with the TDD configuration, wherein the indication is indicative of operation of the network entity in the non-SBFD mode.

Aspect 4: The method of any of aspects 1 through 3, wherein transmission of the indication occurs as part of an initial access procedure.

Aspect 5: The method of aspect 4, wherein the indication is indicative of operation of the network entity in the non-SBFD mode based on participation of the network entity in the initial access procedure and based on the SBFD configuration, a first quantity of bandwidth part switching supported by the network entity, a second quantity of downlink to uplink switching or uplink to downlink switching supported by the network entity, or a combination thereof.

Aspect 6: The method of any of aspects 1 through 3, wherein transmission of the indication occurs while the network entity is in a radio resource control connected mode.

Aspect 7: The method of aspect 6, wherein the indication is indicative of operation of the network entity in the non-SBFD mode based on the network entity being in the radio resource control connected mode and based on a first quantity of bandwidth part switching supported by the network entity, a second quantity of downlink to uplink switching or uplink to downlink switching supported by the network entity, a third quantity of cross link interference experienced by the network entity, a fourth quantity of uplink data available for transmission, a bandwidth part configuration of the SBFD configuration supported by the network entity, or a combination thereof.

Aspect 8: The method of any of aspects 6 through 7, wherein the transmission of the indication occurs as part of a UE assistance information transmission.

Aspect 9: The method of aspect 8, wherein the indication is indicative of operation of the network entity in the non-SBFD mode based on participation of the network entity in transmission of the UE assistance information transmission and based on one or more events of a bandwidth part of the SBFD configuration after a bandwidth part switch supported by the network entity, a change in cell conditions associated with the network entity, or a change in a quantity of uplink data available for transmission.

Aspect 10: The method of aspect 9, wherein the indication indicates the one or more events.

Aspect 11: The method of any of aspects 1 through 3, wherein transmission of the indication occurs while the network entity is in a radio resource control inactive mode or a radio resource control idle mode.

Aspect 12: The method of aspect 11, wherein the transmission of the indication occurs as part of capability signaling or feature support signaling.

Aspect 13: The method of any of aspects 1 through 3, wherein transmission of the indication occurs as part of a random access procedure.

Aspect 14: The method of aspect 13, wherein the indication comprises a random access preamble or the indication is associated with a random access occasion.

Aspect 15: The method of any of aspects 13 through 14, further comprising: transmitting a message, subsequent to the indication, that indicates a condition associated with the non-SBFD mode.

Aspect 16: The method of any of aspects 1 through 15, further comprising: transmitting a message, subsequent to the first information, that indicates a SBFD period associated with the SBFD configuration.

Aspect 17: A method for wireless communications by a network entity, comprising: outputting first information that is indicative of a subband full duplex (SBFD) configuration; outputting second information that is indicative of a time division duplex (TDD) configuration; and obtaining an indication that indicates operation of a second network entity in an SBFD mode or in a non-SBFD mode, wherein operation of the second network entity in the SBFD mode is in accordance with the SBFD configuration, and wherein operation of the second network entity in the non-SBFD mode is in accordance with the TDD configuration.

Aspect 18: The method of aspect 17, further comprising: outputting, responsive to reception of the indication, third information that schedules an uplink or downlink transmission in an SBFD resource in accordance with the SBFD configuration, wherein the indication is indicative of operation of the second network entity in the SBFD mode.

Aspect 19: The method of aspect 17, further comprising: outputting, responsive to reception of the indication, third information that schedules an uplink or downlink transmission in a resource in accordance with the TDD configuration, wherein the indication is indicative of operation of the network entity in the non-SBFD mode.

Aspect 20: The method of any of aspects 17 through 19, wherein reception of the indication occurs as part of an initial access procedure.

Aspect 21: The method of any of aspects 17 through 19, wherein reception of the indication occurs as part of a radio resource control connected mode.

Aspect 22: The method of aspect 21, wherein the reception of the indication occurs as part of a UE assistance information transmission.

Aspect 23: The method of any of aspects 17 through 19, wherein reception of the indication occurs as part of a radio resource control inactive mode or a radio resource control idle mode.

Aspect 24: The method of aspect 23, wherein the reception of the indication occurs as part of a capability signaling or a feature support signaling.

Aspect 25: The method of any of aspects 17 through 19, wherein reception of the indication occurs as part of a random access procedure.

Aspect 26: The method of aspect 25, wherein the indication comprises a random access preamble or the indication is associated with a random access occasion.

Aspect 27: The method of any of aspects 25 through 26, further comprising: outputting, responsive to transmission of the indication, third information that schedules an uplink or downlink transmission in an SBFD resource in accordance with the SBFD configuration, wherein the indication is indicative of operation of the second network entity in the SBFD mode.

Aspect 28: The method of any of aspects 25 through 27, further comprising: obtaining first signaling, subsequent to the indication, that indicates a condition associated with the non-SBFD mode; and outputting second signaling, responsive to the first signaling, that indicates a second SBFD configuration based on the condition.

Aspect 29: The method of any of aspects 17 through 28, further comprising: obtaining a message, subsequent to the first information, that indicates a SBFD period associated with the SBFD configuration.

Aspect 30: A UE for wireless communications, comprising one or more memories storing processor-executable code, and one or more processors coupled with the one or more memories and individually or collectively operable to execute the code to cause the UE to perform a method of any of aspects 1 through 16.

Aspect 31: A UE for wireless communications, comprising at least one means for performing a method of any of aspects 1 through 16.

Aspect 32: A non-transitory computer-readable medium storing code for wireless communications, the code comprising instructions executable by one or more processors to perform a method of any of aspects 1 through 16.

Aspect 33: A network entity for wireless communications, comprising one or more memories storing processor-executable code, and one or more processors coupled with the one or more memories and individually or collectively operable to execute the code to cause the network entity to perform a method of any of aspects 17 through 29.

Aspect 34: A network entity for wireless communications, comprising at least one means for performing a method of any of aspects 17 through 29.

Aspect 35: A non-transitory computer-readable medium storing code for wireless communications, the code comprising instructions executable by one or more processors to perform a method of any of aspects 17 through 29.

The methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive first information that is indicative of a subband full duplex (SBFD) configuration;
receive second information that is indicative of a time division duplex (TDD) configuration; and
transmit an indication that indicates operation of the network entity in an SBFD mode or in a non-SBFD mode, wherein operation of the network entity in the SBFD mode is in accordance with the SBFD configuration, and wherein operation of the network entity in the non-SBFD mode is in accordance with the TDD configuration.

2. The network entity of claim 1, wherein the processing system is configured to:
receive, responsive to transmission of the indication, third information that schedules an uplink or downlink transmission in an SBFD resource in accordance with the SBFD configuration, wherein the indication is indicative of operation of the network entity in the SBFD mode.

3. The network entity of claim 1, wherein the processing system is configured to:
receive, responsive to transmission of the indication, third information that schedules an uplink or downlink transmission in a resource in accordance with the TDD configuration, wherein the indication is indicative of operation of the network entity in the non-SBFD mode.

4. The network entity of claim 1, wherein transmission of the indication occurs as part of an initial access procedure.

5. The network entity of claim 4, wherein the indication is indicative of operation of the network entity in the non-SBFD mode based on participation of the network entity in the initial access procedure and based on the SBFD configuration, a first quantity of bandwidth part switching supported by the network entity, a second quantity of downlink to uplink switching or uplink to downlink switching supported by the network entity, or a combination thereof.

6. The network entity of claim 1, wherein transmission of the indication occurs while the network entity is in a radio resource control connected mode.

7. The network entity of claim 6, wherein the indication is indicative of operation of the network entity in the non-SBFD mode based on the network entity being in the radio resource control connected mode and based on a first quantity of bandwidth part switching supported by the network entity, a second quantity of downlink to uplink switching or uplink to downlink switching supported by the network entity, a third quantity of cross link interference experienced by the network entity, a fourth quantity of uplink data available for transmission, a bandwidth part configuration of the SBFD configuration supported by the network entity, or a combination thereof.

8. The network entity of claim 6, wherein the transmission of the indication occurs as part of a user equipment (UE) assistance information transmission.

9. The network entity of claim 8, wherein the indication is indicative of operation of the network entity in the non-SBFD mode based on participation of the network entity in transmission of the UE assistance information transmission and based on one or more events of a bandwidth part of the SBFD configuration after a bandwidth part switch supported by the network entity, a change in cell conditions associated with the network entity, or a change in a quantity of uplink data available for transmission.

10. The network entity of claim 9, wherein the indication indicates the one or more events.

11. The network entity of claim 1, wherein transmission of the indication occurs while the network entity is in a radio resource control inactive mode or a radio resource control idle mode.

12. The network entity of claim 11, wherein the transmission of the indication occurs as part of capability signaling or feature support signaling.

13. The network entity of claim 1, wherein transmission of the indication occurs as part of a random access procedure.

14. The network entity of claim 13, wherein the indication comprises a random access preamble or the indication is associated with a random access occasion.

15. The network entity of claim 13, wherein the processing system is configured to:
transmit a message, subsequent to the indication, that indicates a condition associated with the non-SBFD mode.

16. The network of claim 1, wherein the processing system is configured to:
transmit a message, subsequent to the first information, that indicates a SBFD period associated with the SBFD configuration.

17. A method for wireless communications by a network entity, comprising:
receiving first information that is indicative of a subband full duplex (SBFD) configuration;
receiving second information that is indicative of a time division duplex (TDD) configuration; and
transmitting an indication that indicates operation of the network entity in an SBFD mode or in a non-SBFD mode, wherein operation of the network entity in the SBFD mode is in accordance with the SBFD configuration, and wherein operation of the network entity in the non-SBFD mode is in accordance with the TDD configuration.

18. The method of claim 17, further comprising:
receiving, responsive to transmission of the indication, third information that schedules an uplink or downlink transmission in an SBFD resource in accordance with the SBFD configuration, wherein the indication is indicative of operation of the network entity in the SBFD mode.

19. The method of claim 17, further comprising:
receiving, responsive to transmission of the indication, third information that schedules an uplink or downlink transmission in a resource in accordance with the TDD configuration, wherein the indication is indicative of operation of the network entity in the non-SBFD mode.

20. A non-transitory computer-readable medium having code for wireless communication stored thereon that, when executed by a network entity, causes the network entity to:
receive first information that is indicative of a subband full duplex (SBFD) configuration;
receive second information that is indicative of a time division duplex (TDD) configuration; and
transmit an indication that indicates operation of the network entity in an SBFD mode or in a non-SBFD mode, wherein operation of the network entity in the SBFD mode is in accordance with the SBFD configuration, and wherein operation of the network entity in the non-SBFD mode is in accordance with the TDD configuration.
